(19) United States
(12) Patent Application Publication
(10) Pub. No.: US 2024/0073847 A1
(43) Pub. Date: Feb. 29, 2024

(54) APPARATUS AND METHOD FOR RADIO ACCESS NETWORK CONTROL

(71) Applicant: Industrial Technology Research Institute, Hsinchu (TW)

(72) Inventors: Chai-Hien Gan, Hsinchu City (TW); Mei Jun Zheng, Hsinchu County (TW)

(73) Assignee: Industrial Technology Research Institute, Hsinchu (TW)

(21) Appl. No.: 17/986,906

(22) Filed: Nov. 15, 2022

(30) Foreign Application Priority Data
Aug. 25, 2022 (TW) 111132087

(51) Int. Cl. H04W 60/04; H04W 8/18

(52) U.S. Cl. CPC H04W 60/04; H04W 8/18

(57) ABSTRACT

An apparatus and a method for radio access network control are provided. A registration state is switched to a closed state and connection information is provided in reply to a base station in response to receiving first identification information of user equipment registered by the base station. In the closed state, in response to receiving second identification information registered by an enrichment information provider, a correspondence between the first and second identification information is established and stored in a mapping table, and the registration state is switched to an open state. In response to receiving enrichment information and the corresponding second identification information provided by the enrichment information provider, the first identification information corresponding to the second identification information is queried from the mapping table, and a control request for the user equipment corresponding to the first identification information is transmitted to the base station according to the enrichment information.

### CROSS-REFERENCE TO RELATED APPLICATION

This application claims the priority benefit of Taiwanese application no. 111132087, filed on Aug. 25, 2022. The entirety of the above-mentioned patent application is hereby incorporated by reference herein and made a part of this specification.

### BACKGROUND

### Technical Field

The disclosure relates to an apparatus and a method for radio access network control.

### Description of Related Art

Open-radio access network (O-RAN) technology provides an open-interface, making a radio access network (RAN) highly scalable, including providing an enrichment information (EI) interface to integrate external enrichment information services so as to optimize the RAN.

In an O-RAN architecture, a RAN intelligent controller (RIC) may identify user equipment (UE) using a RAN-related identifier (ID). An enrichment information provider may adopt user equipment information, such as an IP (Internet Protocol) address, an international mobile subscriber identity (IMSI), or a telephone number, as an identifier.

However, for security reasons, the radio access network adopts a temporary identifier as a RAN user equipment identifier (RAN UE ID), and the identifier may be dynamically updated with connection changes. As a result, an external enrichment information provider cannot directly obtain the RAN UE ID to identify user equipment. When the RAN interacts with the enrichment information provider, association between an enrichment information user equipment identifier (EI UE ID) and the RAN UE ID cannot be directly known. Therefore, behavior of specific user equipment within the radio access network cannot be adjusted according to enrichment information.

### SUMMARY

An exemplary embodiment of the disclosure provides an apparatus for radio access network control. The apparatus includes a first communication interface, a second communication interface, a storage device, and a processor. The first communication interface communicates with a base station. The second communication interface communicates with an enrichment information provider. The storage device stores a mapping table recording correspondence between identification information. The processor is coupled to the first communication interface, the second communication interface, and the storage device. The processor configured to: in response to the first communication interface receiving first identification information of user equipment registered by the base station, switch a registration state to a closed state, and provide connection information in reply to the base station; in the closed state, in response to the second communication interface receiving second identification information registered by the enrichment information provider, establish a correspondence between the first identification information and the second identification information, store the correspondence in the mapping table, and switch the registration state to an open state; and in response to the second communication interface receiving enrichment information and the corresponding second identification information provided by the enrichment information provider, query the first identification information corresponding to the second identification information from the mapping table, and send a control request for the user equipment corresponding to the first identification information to the base station according to the enrichment information.

An exemplary embodiment of the disclosure provides a method for radio access network control applicable to an apparatus for radio access network control. The apparatus includes a first communication interface, a second communication interface, a storage device, and a processor. The method includes the following. By the processor, the first communication interface is utilized to receive first identification information of user equipment registered by a base station, a registration state is switched to a closed state, and connection information is provided in reply to the base station. By the processor in the closed state, the second communication interface is utilized to receive second identification information registered by an enrichment information provider, a correspondence between the first identification information and the second identification information is established, the correspondence is stored in a mapping table in the storage device, and the registration state is switched to an open state. By the processor, the second communication interface is utilized to receive enrichment information and the corresponding second identification information provided by the enrichment information provider, the first identification information corresponding to the second identification information is queried from the mapping table, and the first communication interface is utilized to send a control request for the user equipment corresponding to the first identification information to the base station according to the enrichment information.

In the apparatus and the method for radio access network control of exemplary embodiments of the disclosure, when the user equipment is attached to the base station, the identifier of the user equipment is received and the mapping status is entered, thus the identifier received from the enrichment information provider in this state is regarded as the identification information of the same user equipment, and the correspondence between the two identifiers are automatically established and recorded. Accordingly, when the enrichment information provided by the enrichment information provider is subsequently received, the identifier corresponding to the user equipment can be queried through the identifier enclosed therein, and thus the required control request can be sent to the user equipment. Through the above method, network resources can be effectively arranged, thus improving performance of the network system.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a system architecture diagram of a radio access network according to an embodiment of the disclosure.

FIG. 2 is a flowchart of a method for radio access network control according to an embodiment of the disclosure.

FIG. 3 is a timing diagram of a method for radio access network control according to an embodiment of the disclosure.

FIG. 4 shows a status machine of a method for radio access network control according to an embodiment of the disclosure.

FIG. 5 is a schematic diagram of a method for radio access network control according to an embodiment of the disclosure.

FIG. 6 is a timing diagram of a method for radio access network control according to an embodiment of the disclosure.

FIG. 7 shows a status machine of a method for radio access network control according to an embodiment of the disclosure.

### DESCRIPTION OF THE EMBODIMENTS

In an embodiment of the disclosure, a RAN intelligent controller (RIC) is configured to control registration scheduling of user equipment (UE) at a radio access network (RAN) end (using a RAN user equipment identifier) and an enrichment information (EI) service end (using an EI user equipment identifier), for the RIC to correctly know that the two identifiers are sent by the same UE. In addition, by establishing a mapping table between the RAN user equipment identifier and the EI user equipment identifier, when an enrichment information provider communicates with the RIC by using the EI user equipment identifier, the RIC can know which RAN user equipment identifier is required to be used for resource control on the UE by looking up the table.

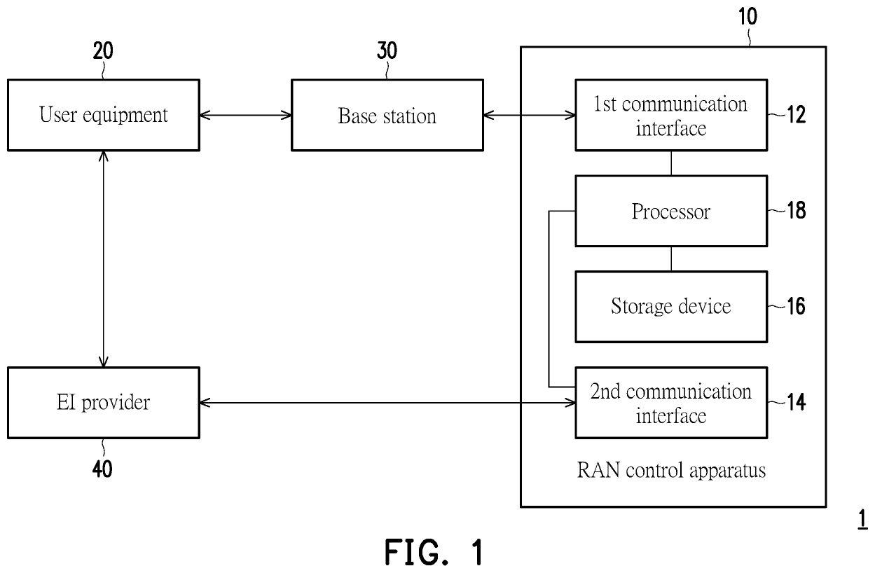

FIG. 1 is a system architecture diagram of a radio access network according to an embodiment of the disclosure. With reference to FIG. 1, a radio access network 1 of this embodiment includes an apparatus for radio access network control 10, user equipment 20, a base station 30, and an enrichment information provider 40.

The apparatus for radio access network control 10 is, for example, a RAN intelligent controller (RIC) including a first communication interface 12, a second communication interface 14, a storage device 16, and a processor 18. The first communication interface 12 serves to communicate with the base station 30, and the second communication interface 14 serves to communicate with the enrichment information provider 40. In an embodiment, the first communication interface 12 is, for example, an E2 interface, and the second communication interface 14 is, for example, an enrichment information (EI) interface, but the embodiment is not limited thereto.

The storage device 16 is, for example, any type of fixed or removable random access memory (RAM), read-only memory (ROM), flash memory, or similar elements or a combination thereof. The storage device 16 stores, for example, a computer program executable by the processor 18. In this embodiment, the storage device 16 stores a mapping table that records a correspondence between identification information.

The processor 18 is, for example, a central processing unit (CPU) or a graphics processing unit (GPU), or any other programmable general-purpose or special-purpose microprocessor, a digital signal processor (DSP), a programmable controller, an application specific integrated circuit (ASIC), a programmable logic device (PLD), or other similar device or a combination thereof. In this embodiment, the processor 18 is coupled to the first communication interface 12, the second communication interface 14, and the storage device 16, and may load and execute the computer program stored in the storage device 16 to perform the method for radio access network control of the embodiments of the disclosure.

The user equipment 20 is, for example, an electronic device such as a mobile phone, a tablet computer, a notebook computer, a desktop computer, and a server used by a user, and adopts mobile communication technology (e.g., 5G) to perform an attach/reattach procedure with the base station 30. When the base station 30 receives an attach/reattach request from the user equipment 20, the base station 30 may transmit a RAN user equipment identifier assigned to the user equipment 20 through the first communication interface 12 to the apparatus for radio access network control 10 for registration.

In addition, the user equipment 20 may initiate a registration process with the enrichment information provider 40 through wired or wireless communication. When the enrichment information provider 40 receives the registration of the user equipment 20, the enrichment information provider 40 registers with the apparatus for radio access network control 10 through the second communication interface 14, and encloses an EI user equipment identifier assigned to the user equipment 20 in a registration message.

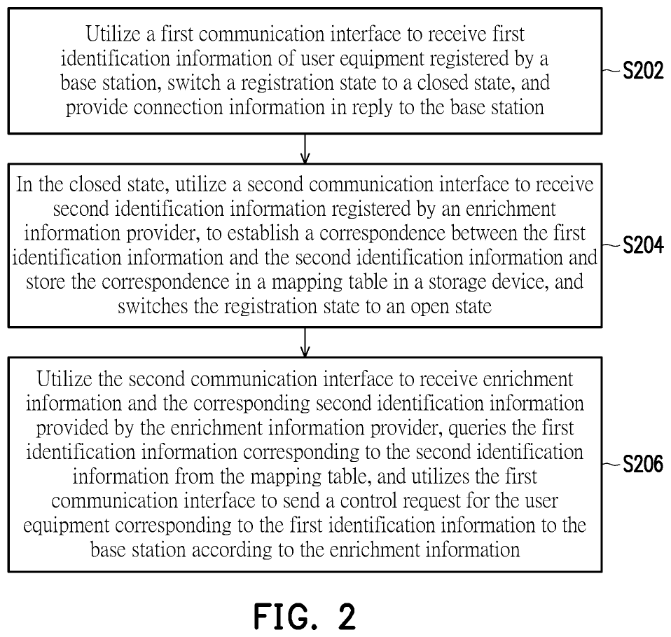

FIG. 2 is a flowchart of a method for radio access network control according to an embodiment of the disclosure. With reference to FIG. 1 and FIG. 2 together, the method of this embodiment is applicable to the apparatus for radio access network control 10 of FIG. 1. Detailed steps of the method for radio access network control of exemplary embodiments of the disclosure accompanied with the elements in the apparatus for radio access network control 10 will now be described below.

In step S202, the processor 18 utilizes the first communication interface 12 to receive first identification information of the user equipment 20 registered by the base station 30, and switches a registration state to a closed state. The apparatus for radio access network control 10 includes, for example, a register for recording the registration state. In an embodiment, the value of the register being 0 indicates the closed state, and the value of the register being 1 indicates an open state, but not limited thereto. The first identification information includes an NG application protocol (NGAP) identifier (ID) of an access and mobility management function (AMF) user equipment (UE), an E1 application protocol (E1AP) ID of base station-centralized unit-distributed unit (gNB-CU-CP) UE, or a UE ID of a radio access network (RAN), but not limited thereto.

When the user equipment 20 is attached to the base station 30, the base station 30 transmits a registration message to the apparatus for radio access network control 10, and the registration message includes a RAN user equipment identifier assigned to the user equipment 20 by the base station 30. When the apparatus for radio access network control 10 receives the registration message, the apparatus for radio access network control 10 records the RAN user equipment identifier in the storage device 16, sets the value of the register to 0 to switch the registration state to the closed state, and provides connection information in reply to the base station 30.

In step S204, in the closed state, the processor 18 utilizes the second communication interface 14 to receive second identification information registered by the enrichment information provider 40, to establish a correspondence between the first identification information and the second identification information and store the correspondence in a mapping table in the storage device 16, and switches the registration state to the open state. The second identification information includes an IP address, an international mobile subscriber identity (IMSI), or a telephone number of the user equipment, but is not limited thereto.

In the closed state, the processor 18 rejects a registration request of the base station 30 for identification information. In other words, even when other user equipment is attached to the base station 30 and the base station 30 registers with the apparatus for radio access network control in the closed state, the processor 18 still does not register the identification information transmitted by the base station 30. Comparatively, the processor 18 waits for the enrichment information provider 40 to register the identification information.

To be specific, after the user equipment 20 completes the attach, the user equipment 20 may, for example, initiate a registration process with the enrichment information provider 40. When the enrichment information provider 40 receives the registration of the user equipment 20, the enrichment information provider 40 registers with the apparatus for radio access network control 10, and encloses identification information (e.g., an EI user equipment identifier) assigned to the user equipment 20 in the registration message. At this time, on the basis that the registration state of the apparatus for radio access network control 10 is in the closed state, the processor 18 may determine that the identification information registered by the enrichment information provider 40 at this time corresponds to the identification information previously registered by the base station 30 (i.e., the two pieces of identification information correspond to the same user equipment 20), establish a correspondence between the two pieces of identification information, and store the correspondence in the mapping table in the storage device 16.

After establishing the mapping table, the processor 18 may switch the registration state to the open state, so that the apparatus for radio access network control 10 can receive the registration request of the base station 30 for the identification information to register identification information of other user equipment. In some embodiments, after switching the registration state to the closed state, the processor 18 may, for example, accumulate a waiting time for which the processor 18 did not receive the second identification information registered by the enrichment information provider 40, and switches the registration state to the open state when the waiting time exceeds a predetermined time. Accordingly, it is possible prevent the registration of other user equipment from being hindered or delayed by an excessively long registration time of the user equipment 20.

In step S206, the processor 18 utilizes the second communication interface 14 to receive enrichment information and the corresponding second identification information provided by the enrichment information provider 40, queries the first identification information corresponding to the second identification information from the mapping table, and utilizes the first communication interface 12 to send a control request for the user equipment 20 corresponding to the first identification information to the base station 30 according to the enrichment information, while the base station 30 controls resources allocated to the user equipment 20. The control request is, for example, requesting the base station 30 to adjust a resource allocation, a transmission rate, a transmission priority, or a handover for the user equipment 20, but this embodiment is not limited to this.

Through the above method, the apparatus for radio access network control 10 of this embodiment can find out a correspondence between the RAN user equipment identifier and the EI user equipment identifier of the same user equipment 20. Therefore, the apparatus for radio access network control 10 may effectively arrange resources by utilizing the information provided by the enrichment information provider 40, thus improving network system performance and user experience. The enrichment information includes position information, signal intensity, or environmental information.

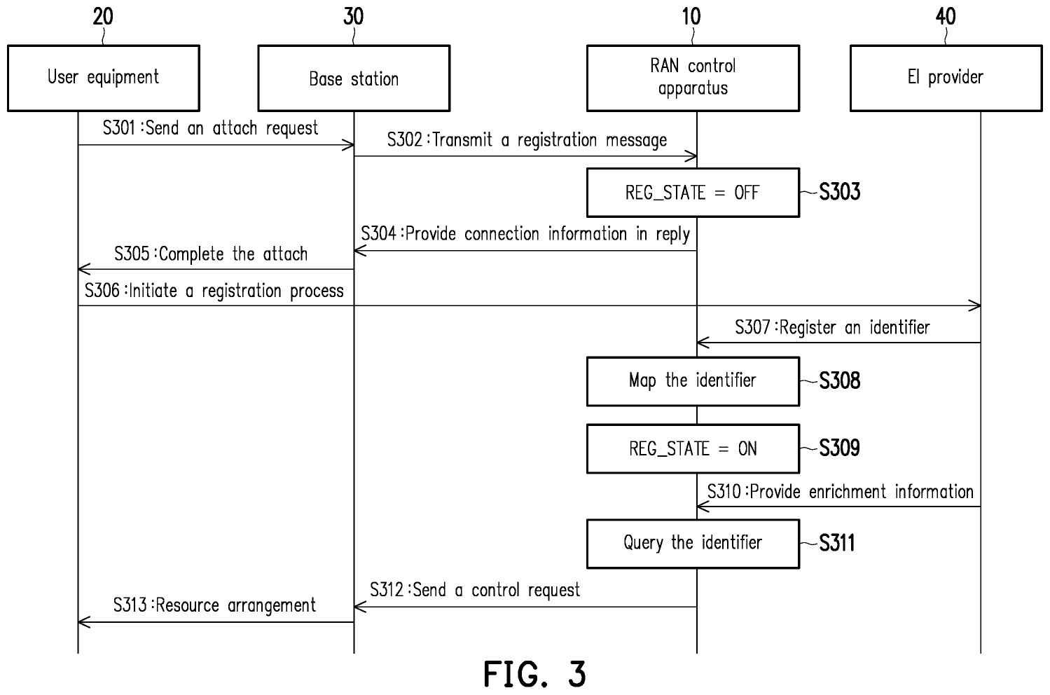

FIG. 3 is a timing diagram of a method for radio access network control according to an embodiment of the disclosure. With reference to FIG. 1 and FIG. 3 together, the method of this embodiment is applicable to the apparatus for radio access network control 10 of FIG. 1. The timing of the method for radio access network control of exemplary embodiments of the disclosure accompanied with the elements in the apparatus for radio access network control 10 will now be described below.

In step S301, the user equipment 20 initiates an attach/reattach procedure to the base station 30 in order to obtain network services.

In step S302, after the base station 30 receives an attach/reattach request from the user equipment 20, the base station 30 transmits a RAN user equipment identifier assigned to the user equipment 20 to the apparatus for radio access network control 10 through an E2 interface.

In step S303, after receiving a registration message transmitted by the base station 30, the apparatus for radio access network control 10 determines whether a registration state is an open state (i.e., REG_STATE=ON). If so, the apparatus for radio access network control 10 accepts the registration and sets the registration state to a closed state (i.e., REG_STATE=OFF). Comparatively, the apparatus for radio access network control 10 does not enter an identifier mapping process.

In step S304, the apparatus for radio access network control 10 provides connection information in reply to the base station 30. In step S305, the attach/reattach procedure is completed.

In step S306, the user equipment 20 initiates a registration process with the enrichment information provider 40 after each time of the attach/reattach procedure is completed.

In step S307, after receiving the registration of the user equipment 20, the enrichment information provider 40 registers with the apparatus for radio access network control 10 through an EI interface, and encloses an EI user equipment identifier assigned to the user equipment 20 in the registration message.

In step S308, after receiving a registration request of the enrichment information provider 40, the apparatus for radio access network control 10 establishes a correspondence between the RAN user equipment identifier obtained in step S302 and the EI user equipment identifier in the current registration message and stores the correspondence in an identifier mapping table in the storage device 16.

In step S309, the identifier mapping process ends. At this time, the apparatus for radio access network control 10 sets the registration state to the open state (i.e., REG_STATE=ON), and may accept registration of the next user equipment in the open state.

In step S310, the enrichment information provider 40 sends enrichment information of the user equipment 20 to the apparatus for radio access network control 10.

In step S311, the apparatus for radio access network control 10 uses the EI user equipment identifier enclosed in the enrichment information to query the corresponding RAN user equipment identifier from the previously stored identifier mapping table.

In step S312, the apparatus for radio access network control 10 sends a control request for the user equipment 20 to the base station 30 in order to perform resource control on the user equipment 20 according to the enrichment information.

In step S313, when the base station 30 receives the control request, the base station 30 performs relevant resource arrangement for the user equipment 20.

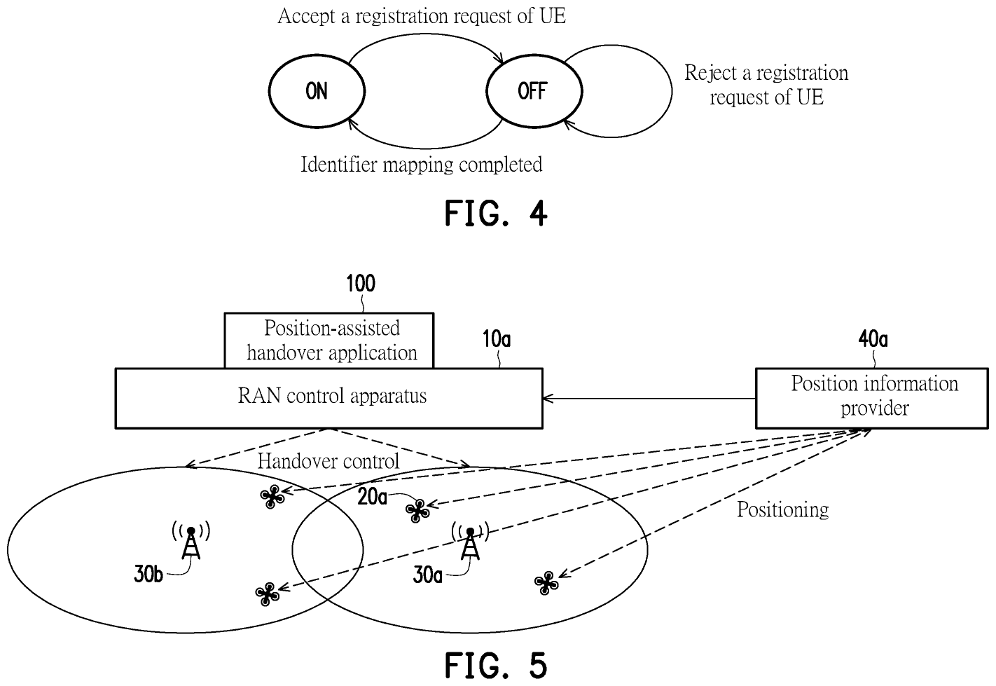

FIG. 4 shows a status machine of a method for radio access network control according to an embodiment of the disclosure. With reference to FIG. 4, when the status is ON, it indicates a state where an apparatus for radio access network control can accept registration of user equipment (UE); when the status is OFF, it indicates that an identifier mapping process is currently in progress, so the apparatus for radio access network control rejects a registration request of any user equipment; after the identifier mapping is completed, the apparatus for radio access network control switches the status from OFF to ON to accept registration of the next user equipment.

Through the above method, the apparatus for radio access network control can effectively arrange the resources allocated by the base station to the user equipment according to the enrichment information provided by the enrichment information provider to improve network system performance and user experience.

In an embodiment of the disclosure, the method for radio access network control is further applied to fast handover of an unmanned vehicle, i.e., switching from one network to another between different base stations.

FIG. 5 is a schematic diagram of a method for radio access network control according to an embodiment of the disclosure. With reference to FIG. 5, in this embodiment, a position information provider 40a is utilized to locate an unmanned vehicle 20a to provide position information of the unmanned vehicle 20a to an apparatus for radio access network control 10a. The apparatus for radio access network control 10a performs handover control by executing a position-assisted handover application 100. The unmanned vehicle 20a is, for example, an unmanned aerial vehicle (UAV) or other vehicles, which is not limited in this disclosure.

The position information provider 40a reports the position information at an interval of, for example, 10 milliseconds (ms). Comparatively, the unmanned vehicle 20a determines whether to perform handover by measuring signal intensity of base stations 30a and 30b around, and reports the signal intensity at an interval of, for example, 20 ms, 40 ms, 80 ms, or 60 ms. The interval at which the position information provider 40a reports the position information is less than the interval at which the unmanned vehicle 20a reports the signal intensity, which can therefore help the apparatus for radio access network control 10a to perform handover control on the unmanned vehicle 20a.

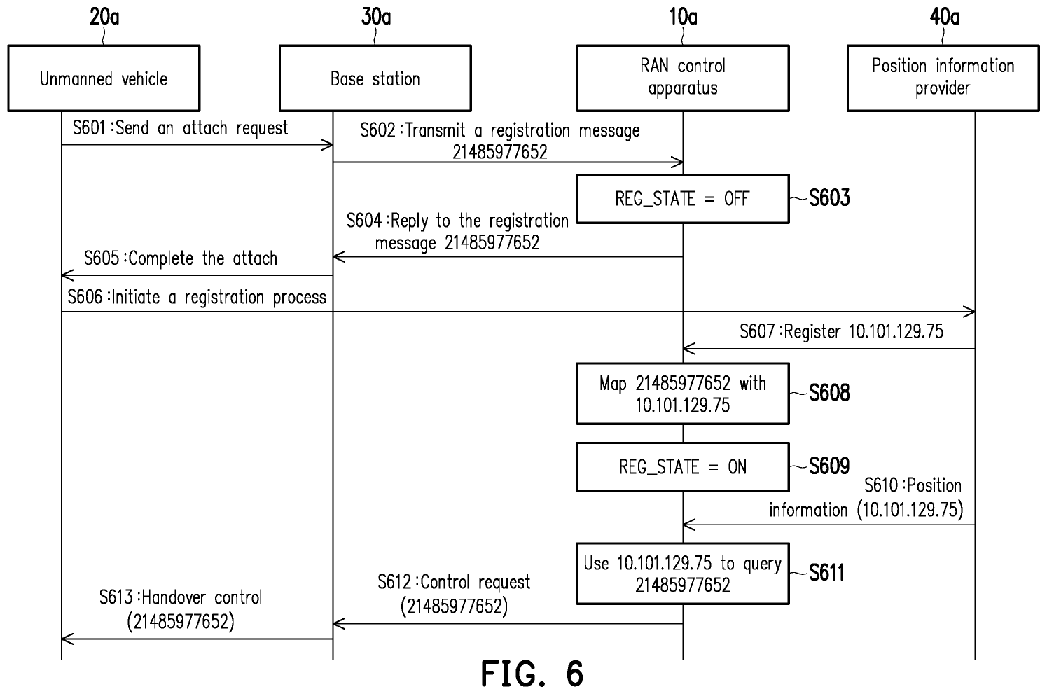

FIG. 6 is a timing diagram of a method for radio access network control according to an embodiment of the disclosure. With reference to FIG. 5 and FIG. 6 together, the method of this embodiment is applicable to the apparatus for radio access network control 10a of FIG. 5. The timing of the method for radio access network control of exemplary embodiments of the disclosure accompanied with the elements in the apparatus for radio access network control 10a will now be described below.

In step S601, the unmanned vehicle 20a initiates an attach/reattach procedure to the base station 30a in order to obtain network services.

In step S602, after the base station 30a receives an attach/reattach request from the unmanned vehicle 20a, the base station 30a transmits a RAN user equipment identifier (21485977652) assigned to the unmanned vehicle 20a as a registration message to the apparatus for radio access network control 10a for registration through an E2 interface.

In step S603, after receiving the registration message transmitted by the base station 30a, the apparatus for radio access network control 10a determines whether a registration state is an open state (i.e., REG_STATE=ON). If so, the apparatus for radio access network control 10a accepts the registration and sets the registration state to a closed state (i.e., REG_STATE=OFF). Comparatively, the apparatus for radio access network control 10a does not enter an identifier mapping process.

In step S604, the apparatus for radio access network control 10a provides the registration message (21485977652) in reply to the base station 30a. In step S605, the attach/reattach procedure is completed.

In step S606, the unmanned vehicle 20a initiates a registration process with the position information provider 40a after each time of the attach/reattach procedure is completed.

In step S607, after receiving the registration of the unmanned vehicle 20a, the position information provider 40a registers with the apparatus for radio access network control 10a through an EI interface, and encloses an EI user equipment identifier assigned to the unmanned vehicle 20a, for example an IP address (10.101.129.75) of the unmanned vehicle 20a, in the registration message.

In step S608, after receiving a registration request of the position information provider 40a, the apparatus for radio access network control 10a establishes a correspondence between the RAN user equipment identifier (21485977652) obtained in step S602 and the EI user equipment identifier (10.101.129.75) in the current registration message and stores the correspondence in an identifier mapping table.

In step S609, the identifier mapping process ends. At this time, the apparatus for radio access network control 10a sets the registration state to the open state (i.e., REG_STATE=ON), and may accept registration of the next user equipment in the open state.

In step S610, the position information provider 40a sends position information of the unmanned vehicle 20a to the apparatus for radio access network control 10a.

In step S611, the apparatus for radio access network control 10a uses the EI user equipment identifier (10.101.129.75) enclosed in the position information to query the corresponding RAN user equipment identifier (21485977652) from the previously stored identifier mapping table.

In step S612, the apparatus for radio access network control 10a sends a control request for the unmanned vehicle 20a to the base station 30a in order to perform handover control on the unmanned vehicle 20a. The control request includes the RAN user equipment identifier (21485977652).

In step S613, when the base station 30a receives the control request, the base station 30a assists with handover control on the unmanned vehicle 20a according to the RAN user equipment identifier (21485977652), for example, handover from the network provided by the base station 30a to the network provided by the base station 30b.

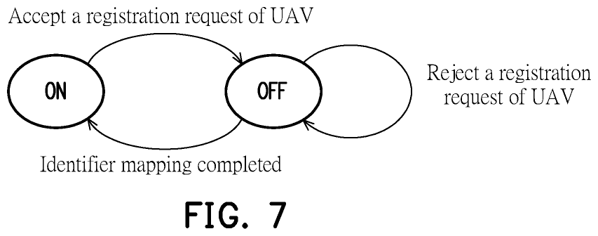

FIG. 7 shows a status machine of a method for radio access network control according to an embodiment of the disclosure. With reference to FIG. 7, when the status is ON, it indicates a state where an apparatus for radio access network control can accept registration of an unmanned vehicle (UAV); when the status is OFF, it indicates that an identifier mapping process is currently in progress, so the apparatus for radio access network control rejects a registration request of any unmanned vehicle; after the identifier mapping is completed, the apparatus for radio access network control switches the status from OFF to ON to accept registration of the next unmanned vehicle.

Through the above method, the apparatus for radio access network control can perform handover control on the unmanned vehicle according to the position information provided by the position information provider, and improve user experience.

In summary of the foregoing, in the apparatus and the method for radio access network control of exemplary embodiments of the disclosure, through the predetermined identifier mapping mechanism, whenever the identifier of the user equipment is received from the base station, the mapping status is entered, and a correspondence between the identifier received from the enrichment information provider and the identifier received from the base station in this state is established and recorded in the mapping table. Accordingly, when the enrichment information provided by the enrichment information provider is subsequently received, the identifier enclosed therein can be used to query the identifier of the corresponding user equipment to thus send the required control request to the user equipment. Through the above method, network resources can be effectively arranged, thus improving performance of the network system.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An apparatus for radio access network control comprising:
a first communication interface communicating with a base station;
a second communication interface communicating with an enrichment information provider;
a storage device storing a mapping table recording correspondence between identification information; and
a processor coupled to the first communication interface, the second communication interface, and the storage device, the processor configured to:
in response to the first communication interface receiving first identification information of user equipment registered by the base station, switch a registration state to a closed state, and provide connection information in reply to the base station;
in the closed state, in response to the second communication interface receiving second identification information registered by the enrichment information provider, establish a correspondence between the first identification information and the second identification information, store the correspondence in the mapping table, and switch the registration state to an open state; and
in response to the second communication interface receiving enrichment information and the corresponding second identification information provided by the enrichment information provider, query the first identification information corresponding to the second identification information from the mapping table, and send a control request for the user equipment corresponding to the first identification information to the base station according to the enrichment information.

2. The apparatus of claim 1, wherein after switching the registration state to the closed state, the processor is further configured to reject a registration request of the base station for the identification information.

3. The apparatus of claim 1, wherein after switching the registration state to the closed state, the processor is further configured to accumulate a waiting time for which the second identification information is not received, and switch the registration state to the open state when the waiting time exceeds a predetermined time.

4. The apparatus of claim 1, wherein the control request comprises a request for the base station to adjust a resource allocation, a transmission rate, a transmission priority, or a handover for the user equipment.

5. The apparatus of claim 1, wherein the first identification information comprises an NG application protocol (NGAP) identifier (ID) of an access and mobility management function (AMF) user equipment (UE), an E1 application protocol (E1AP) ID of base station-centralized unit-distributed unit (gNB-CU-CP) UE, or a UE ID of a radio access network (RAN).

6. The apparatus of claim 1, wherein the second identification information comprises an IP address, an international mobile subscriber identity (IMSI), or a telephone number of the user equipment.

7. The apparatus of claim 1, wherein the enrichment information comprises position information, signal intensity, or environmental information.

8. A method for radio access network control applicable to an apparatus for radio access network control, the apparatus comprising a first communication interface, a second communication interface, a storage device, and a processor, and the method comprising:
by the processor, utilizing the first communication interface to receive first identification information of user equipment registered by a base station, switching a registration state to a closed state, and providing connection information in reply to the base station;
by the processor in the closed state, utilizing the second communication interface to receive second identification information registered by an enrichment information provider, establishing a correspondence between the first identification information and the second identification information, storing the correspondence in a mapping table in the storage device, and switching the registration state to an open state; and
by the processor, utilizing the second communication interface to receive enrichment information and the corresponding second identification information provided by the enrichment information provider, querying the first identification information corresponding to the second identification information from the mapping table, and utilizing the first communication interface to send a control request for the user equipment corresponding to the first identification information to the base station according to the enrichment information.

9. The method of claim 8, wherein after switching the registration state to the closed state, the method further comprises:
rejecting a registration request of the base station for the identification information.

10. The method of claim 8, wherein after switching the registration state to the closed state, the method further comprises:
accumulating a waiting time for which the second identification information is not received, and switching the registration state to the open state when the waiting time exceeds a predetermined time.

11. The method of claim 8, wherein the control request comprises requesting the base station to adjust a resource allocation, a transmission rate, a transmission priority, or a handover for the user equipment.

12. The method of claim 8, wherein the first identification information comprises an NG application protocol (NGAP) identifier (ID) of an access and mobility management function (AMF) user equipment (UE), an E1 application protocol (E1AP) ID of base station-centralized unit-distributed unit (gNB-CU-CP) UE, or a UE ID of a radio access network (RAN).

13. The method of claim 8, wherein the second identification information comprises an IP address, an international mobile subscriber identity (IMSI), or a telephone number of the user equipment.

14. The method of claim 8, wherein the enrichment information comprises position information, signal intensity, or environmental information.
